(19) United States
(12) Patent Application Publication
(10) Pub. No.: US 2007/0268988 A1
(43) Pub. Date: Nov. 22, 2007

(54) Method and system for optimal receive diversity combining

(75) Inventors: Ahmadreza Hedayat, Allen, TX (US); Hang Jin, Plano, TX (US); Li Guo, Zrviz, TX (US); John Grabner, Plano, TX (US)

Correspondence Address: L. HOWARD CHEN;KIRKPATRICK & LOCKHART PRESTON GATES ELLIS, LLP, 55 SECOND STREET, # 1700, SAN FRANCISCO, CA, 94105, US

(73) Assignee: Navini Networks, Inc.

(21) Appl. No.: 11/585,581

(22) Filed: Oct. 24, 2006

Related U.S. Application Data
(60) Provisional application No. 60/801,935, filed on May 19, 2006.

(51) Int. Cl. H04L 1/02; H04B 7/10

(52) U.S. Cl. 375/347

(57) ABSTRACT

The present invention discloses a method and system for receive signal diversity combining that achieves the high effective SNR and high coding gain. The receive signal diversity combining method combines two or more received diversified signals of a predetermined original message and employs a Maximum Likelihood (ML) detection method to process the diversified signals to generate Log-Likelihood Ratio (LLR) data to exploit the available signal diversity and coding gain of each bit and to help the channel decoder to correctly determine the predetermined original message.

### CROSS REFERENCE

The present application claims the benefit of U.S. Provisional Application Ser. 60/801,935, which was filed on May 19, 2006.

### BACKGROUND

The present invention relates to a method and system designed for providing improved receive diversity combining of radio signals for a wireless communication system for better detecting an original transmitted message.

Diversity combining is an efficient technique for improving the quality of a wireless communication system. It takes advantage of the random nature of radio propagation.

In a wireless communication system that supports diversity combining, transmit diversity means that the transmitter transmits multiple copies of the signal of a message. Receive diversity means that the receiver receives multiple copies of signals of the same message and combines them according to certain rules to enhance the reliability of the detection of the message.

When employing diversity combining, the wireless receiver has to process the diversified signals obtained in order to maximize the effective Signal to Noise Ratio (SNR) of the system. By exploiting the redundancy in the diversified signals, the receiver can acquire higher quality (i.e. with better SNR) information from the redundant signals and thus make a good decision about the original message. The diversified signals can be obtained through time diversity, spatial diversity and frequency diversity.

In a time diversity system, a transmitter sends multiple copies of signals of a message at different times, and a receiver receives multiple copies of signals of the message at different times. In a spatial diversity system, the transmitter transmits multiple copies of signals of a message at different antennas placed apart in space and the receiver receives multiple copies of signals of the message at different antennas placed apart in space. In a frequency diversity system, the transmitter transmits multiple copies of signals of a message at different frequencies from one or more antennas placed apart in space and the receiver receives multiple copies of signals of the same message at different frequencies with one or more antennas.

A wireless communication system can implement one or more diversity schemes simultaneously. For example, a transmitter can send the signal of a message twice at different times, at different frequencies and at different antennas and a receiver can receive the signals of the same message twice at different times, at different frequencies and at different antennas.

The number of antennas on the transmitter and the receiver may define the type of wireless communication system. A system is a Single-Input Single-Output (SISO) if there is a single transmitter antenna and a single receiver antenna. A system is Single-Input Multiple-Output (SIMO) if there is a single transmitter antenna and multiple receiver antennas. A system is Multiple-Input Single-Output (MISO) if there are multiple transmitter antennas and a single receiver antenna. A system is Multiple-Input Multiple-Output (MIMO) if there are multiple transmitter antennas and multiple receiver antennas. One type of the spatial diversity combining system is the MIMO system. The MIMO system provides assurance for improved coverage and increased reliability in a wireless communication system.

There are several receive diversity reception methods employed in the receiver systems. The most common ones are Selection Diversity (SD), Equal Gain Combining (EGC) and Maximal Ratio Combining (MRC) methods. Among them, the MRC method is the optimal diversity combining technique for improving the effective SNR. It adds the signals received by two or more receiver antennas and provides gain in proportion to the individual receiver's signal amplitude but in inverse proportion to the individual receiver's noise power.

Channel coding must be used in order to mitigate the errors that occur due to noise, channel fading and interference. Channel coding is accomplished by selectively introducing redundant bits into the transmitted message. These additional bits will allow detection and correction of bit errors in the received message and increase the reliability of the information.

Among various channel coding methods, bit-interleaved coded modulation (BICM) has emerged as a simple, scalable, and efficient method in various wireless communication standards. In BICM, the coding and the modulation are distinct operations. First, a traditional binary channel code is applied to the input message. The coded bits (codewords) are then passed through an interleaver and then mapped from binary codewords to a binary or non-binary modulation. After the signal is received by the receiver, it is demodulated and deinterleaved. The estimated codewords are then decoded, for example using an iterative decoder.

Receive diversity with MRC method is a good diversity reception method for improving the effective SNR, and BICM is the most scalable and efficient channel coding method. However, a wireless communication system that employs bit-interleaved (BI) channel code with receive diversity that adopts MRC method may not achieve optimal performance. In other words, although each processing method alone is an optimal method, the combination of the two methods introduces sub-optimality in the signal estimation.

What is needed is an improved receive diversity combining method for wireless communication systems.

### SUMMARY

The present invention discloses a method and system for receive diversity combining that achieves high SNR and coding gain. The receive diversity combining method combines two or more received diversified signals of a predetermined original message and employs the Maximum Likelihood (ML) detection algorithm to process the diversified signals to generate Log-Likelihood Ratio (LLR) data. The ML detection algorithm exploits the available signal diversity and coding gain.

The diversified signals are transmitted and received with one of or a combination of the following diversification methods: time diversity, spatial diversity and frequency diversity.

### BRIEF DESCRIPTION OF THE DRAWING

The drawings accompanying and forming part of this specification are included to depict certain aspects of the invention. A clearer conception of the invention and of the operation of the system provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates a single antenna system with a soft bit detector and a channel decoder.

FIG. 2 illustrates a receive diversity combining system with a summation module.

FIG. 3 illustrates a receive diversity combining system with a module employing the MRC method.

FIG. 4 illustrates a receive diversity combining system according to one embodiment of the present invention.

### DESCRIPTION

The present invention discloses an improved receive diversity combining method that combines diversified signals to improve the effective SNR in a wireless communication system and to obtain higher coding gain. The receive diversity combining method disclosed in this invention applies to any receiver that supports any combination of the previously mentioned diversity mechanisms, i.e. time, spatial or frequency. While implementing the inventive methods in the system, a diversity combining system or module can be located between a down converter and a channel decoder of a receiver in a wireless communication system although various other designs can also be reasonably expected.

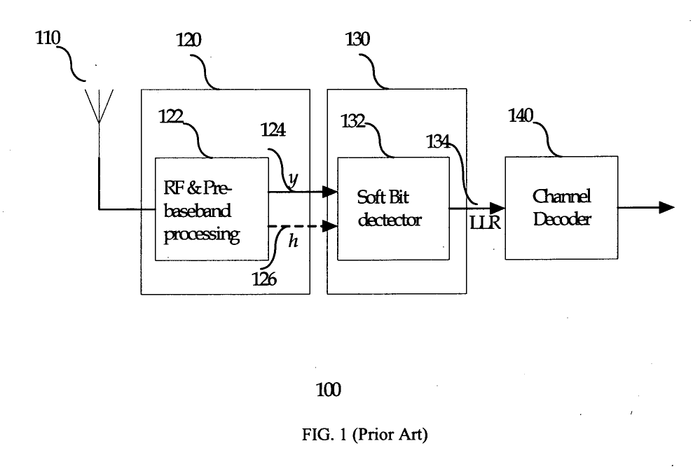

FIG. 1 100 illustrates the receive chain of a wireless SISO communication system without receive diversity combing. Symbol 110 refers to the antenna of the wireless station. A receive signal processing module 120 comprises of a RF and pre-baseband processing module 122 that processes incoming signals and produces a down-converted received signal y 124 and channel fading coefficient h 124. A soft detection module 130 comprises of the soft bit detector module 132 that generates an output of a log-likelihood ratio (LLR) data 134.

The RF and pre-baseband processing module 122 of the radio receiver down-converts the received RF signal and sends the processed signal y 124 and channel fading coefficient h 126, which is also obtained in the pre-baseband processing module, to the soft bit detector module 132. The soft bit detector module 132 derives the LLR data 134 of the kth bit of the transmitted symbol s according to the following algorithm.

Given the down-converted received signal y and the channel fading coefficient h, the probability when the kth bit of the transmitted symbol s is equal to bε{0, 1} is:

$$\begin{matrix}{λ}_{k} ( y , b ) = log {\sum }_{x ∈ {S}_{k , b}} Pr ( y \vert s , h ) \\ ≡ log {\sum }_{x ∈ {S}_{k , b}} exp ( - \frac{{\vert y - hx \vert}^{2}}{2 {σ}^{2}} ) ,\end{matrix} \qquad ( 1 )$$

where S_{k,b} is a subset of the constellation whose symbols have the kth bit equal to b, and σ² is the variance of normal noise.

The log-likelihood ratio (LLR) data 134, Γₖ, of the kth bit of the transmitted symbol s is then equal to the difference of the probability λₖ for the two choices of b, i.e.,

Γₖ(y)=λₖ(y, 0)−λₖ(y, 1) (2)

Depending on the size of the constellation, the above metric calculation could be computationally complex. Using the approximation

$$log {\sum }_{j} {x}_{j} \approx {max}_{j} log {x}_{j} ,$$

the metric in Equation (2) becomes:

$${Γ}_{k} ( y ) \approx \frac{1}{2 {σ}^{2}} ( {min}_{x ∈ {S}_{k , 0}} {\vert y - hx \vert}^{2} - {min}_{x ∈ {S}_{k , 1}} {\vert y - hx \vert}^{2} ) \qquad ( 3 )$$

Equation (3) is the estimated LLR 134 of the receive channel. The channel decoder 140 processes the LLR 134 and the original message sent from the wireless transmitter is then retrieved.

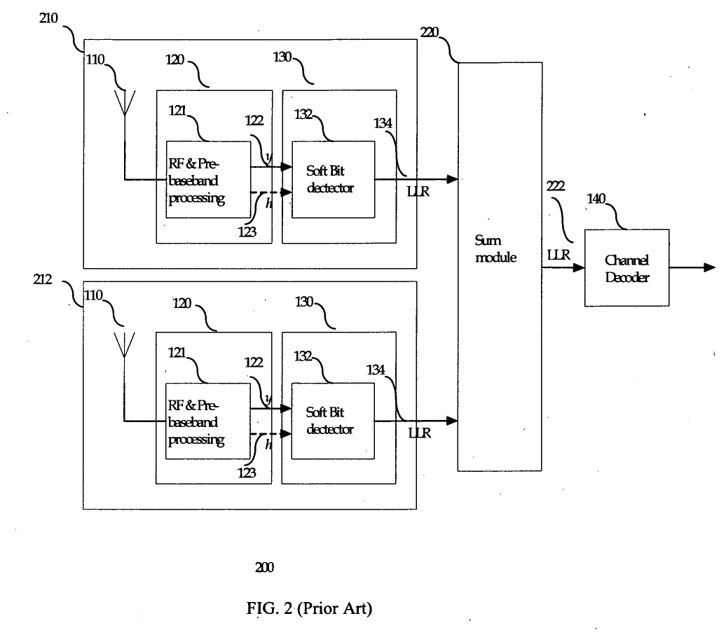

One embodiment of the receive diversity combining is to process received diversified signals separately and to perform the soft bit detection. The output of each soft bit detector module, LLR 134, is then summed to obtain the summation of LLRs. FIG. 2 illustrates one such receive diversity combining system 200 with two receive processing chains.

Blocks 210 and 212 both have similar components. They all have the antenna 110, the receive signal processing module 120 and soft detection module 130, as described in FIG. 1. The output of individual LLR 134 from the soft bit decoder 132 is summed in a summation module 220, resulting in a summed LLR 222. The summed LLR 222 is then processed by the channel decoder 140.

In one example, in a time receive diversity combining system, blocks 210 and 212 represent the same receive chain operating at different times or frequencies, hence indicated as two receive chains. Similarly, the same configuration can represent a spatial receive diversity combining system, in which blocks 210 and 212 are two physical realizations of the receive chain for receiving spatial diversified signal. It is further understood that more than two receive chains can be implemented in reality, although only two receive chains are shown here for illustration purposes.

The summed LLR 222 of the kth bit of the transmitted symbol s based on the receive diversity combining system, described in FIG. 2, is equal to:

$${Γ}_{sub} = \frac{1}{2 {σ}^{2}} ( {min}_{x ∈ {S}_{k , 0}} {\vert {y}_{1} - {h}_{1} x \vert}^{2} - {min}_{x ∈ {S}_{k , 1}} {\vert {y}_{1} - {h}_{1} x \vert}^{2} ) + \frac{1}{2 {σ}^{2}} ( {min}_{x ∈ {S}_{k , 0}} {\vert {y}_{2} - {h}_{2} x \vert}^{2} - {min}_{x ∈ {S}_{k , 1}} {\vert {y}_{2} - {h}_{2} x \vert}^{2} ) \qquad ( 4 )$$

in which the LLR data 222 produced by equation 4 is deemed as sub-optimal.

Another embodiment of the receive diversity combining system is to process received diversified signals with a module employing an MRC method. The generalized formula for the receive diversity combining system with the module employing MRC method for the diversity combining of receive signals is further described below.

Let the vector (y₁, y₂, . . . y_{N}) describe the set of down-converted, received signals of the channels carrying the diversified signals, and vector (h₁ h₂, . . . , h_{N}) describe the set of channel fading coefficients, each of which is associated with one of the diversified signals, in the same order. With the module employing the MRC method, the output signal of each receive chain yᵢ is multiplied by h*ᵢ, the complex conjugate of its channel fading coefficient hᵢ. The multiplied outputs are then summed to form a hybrid signal y, i.e. the module employing MRC method calculates hybrid signal y according to the following equation,

$$y = {\sum }_{i = 1}^{N} {y}_{i} {h}_{i}^{*} .$$

Assume the channel model of each receive chain i is yᵢ=hᵢs+nᵢ where yᵢ is the down-converted received signal, s is the transmitted symbol, hᵢ is the channel fading coefficient and nᵢ is the random noise, the above equation becomes

$$y = s {\sum }_{i = 1}^{N} {h}_{i} {h}_{i}^{*} + {\sum }_{i = 1}^{N} {n}_{i} {h}_{i}^{*} , \qquad ( 5 )$$

where s is the transmitted symbol, hᵢ is the channel fading coefficient, h*ᵢ is the complex conjugate of hᵢ and nᵢ is the random noise of receive chain i. In addition to y, the effective channel coefficient H is also calculated by the MRC module:

$$H = {\sum }_{i = 1}^{N} {h}_{i} {h}_{i}^{*} = {\sum }_{i = 1}^{N} {\vert {h}_{i} \vert}^{2}$$

The hybrid signal y, which is produced by the module employing the MRC method, together with the effective channel coefficient H, is input to the soft bit detector where the soft information of each bit is calculated.

The LLR data, Γₖ, of the kth bit of the transmitted symbol s in the receive diversity combining system with the module employing the MRC method is then equal to:

$${Γ}_{k} ( {y}_{1} , … , {y}_{N} ) = \frac{1}{2 {σ}^{2}} ( {min}_{x ∈ {S}_{k , 0}} {\vert {\sum }_{i = 1}^{N} {y}_{i} {h}_{i}^{*} - x {\sum }_{i = 1}^{N} {\vert {h}_{i} \vert}^{2} \vert}^{2} - {min}_{x ∈ {S}_{k , 1}} {\vert {\sum }_{i = 1}^{N} {y}_{i} {h}_{i}^{*} - x {\sum }_{i = 1}^{N} {\vert {h}_{i} \vert}^{2} \vert}^{2} ) . \qquad ( 6 )$$

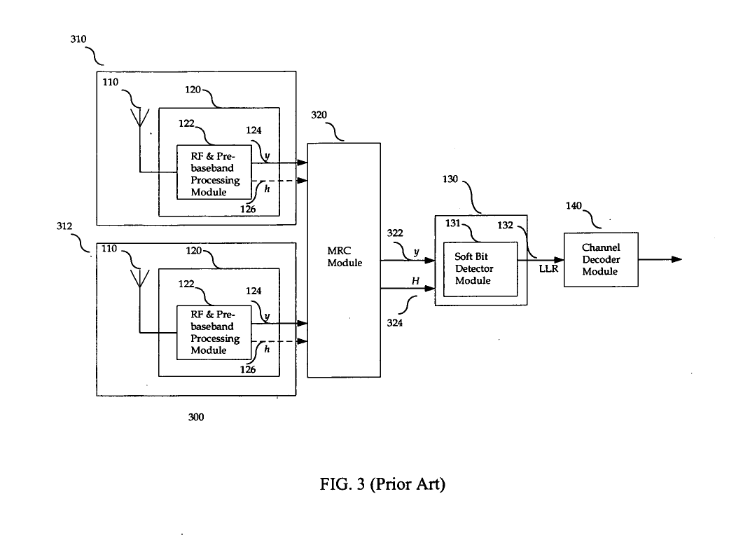

FIG. 3 illustrates one embodiment of the receive diversity combining system 300 with two receive processing chains that uses an MRC module for the diversity combining of receive signals. Blocks 310 and 312 both contain the antenna 110 and the receive signal processing module 120, as described in FIG. 1.

In each block, the RF and pre-baseband processing module 122 down-converts the received RF signal and sends the down-converted received signal yᵢ 124 and channel fading coefficient hᵢ 126 to the MRC module 320.

In FIG. 3, for example, it is deemed as a time receive diversity combining system, with blocks 310 and 312 being the same receive chain but operating at different time instances, or different frequency ones. FIG. 3 can also represent, for example, a spatial receive diversity combining system, with blocks 310 and 312 being two independent receive chains physically separated from each other. It is further understood that more than two receive chains can be implemented in reality although only two receive chains are shown here for illustration purposes. With the processing of the received diversified signals, the MRC module 320 linearly combines the down-converted received signal yᵢ 124 and hᵢ 126 from every receive chain i and generates the hybrid signal y 322 and the effective channel coefficient H 324 to provide maximum effective SNR.

The LLR data, Γₖ, of the kth bit of the transmitted symbol s of the receive diversity combining system with the module employing MRC method described in FIG. 3 is then equal to:

$${Γ}_{MRC} = \frac{1}{2 {σ}^{2}} ( {min}_{x ∈ {S}_{k , 0}} {\vert {y}_{1} {h}_{1}^{*} + {y}_{2} {h}_{2}^{*} + x ( {\vert {h}_{1} \vert}^{2} + {\vert {h}_{2} \vert}^{2} ) \vert}^{2} - {min}_{x ∈ {S}_{k , 1}} {\vert {y}_{1} {h}_{1}^{*} + {y}_{2} {h}_{2}^{*} + x ( {\vert {h}_{1} \vert}^{2} + {\vert {h}_{2} \vert}^{2} ) \vert}^{2} ) \qquad ( 7 )$$

The receive diversity combining system that uses the method for the diversity combining of receive signals achieves the available spatial diversity in the multiple received signals environment. However, it does not accomplish the highest achievable coding gain when combined with an arbitrary channel code.

One perspective toward a joint multiple receive antenna and a channel coded system is the constitution of redundant channel codes via multiple received signals. For example, assume a rate ½ bit-interleaved convolutional code is employed, and that the base station has four antennas. The four received copies of the transmitted message can be thought of as a repetition code within the original convolutional code, which results in a channel code with rate ⅛. Therefore, to extract the LLR of the bits, it is optimal to consider all the received signals simultaneously.

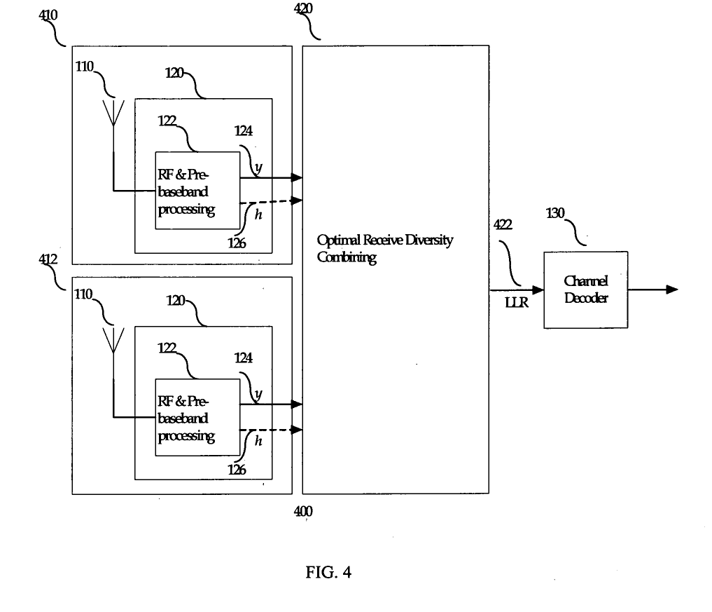

FIG. 4 is one exemplary embodiment of the optimal receive diversity combining system 400 of the disclosed invention that has two or more receive processing chains. Blocks 410 and 412 both include the antenna 110, the receive signal processing module 120, as described in FIG. 1.

The generalized formula for the optimal receive diversity combining system is described below. The described optimal receive diversity combining system achieves the effective SNR. When combined with an arbitrary channel code, the optimal receive diversity combining system exploits the higher coding gain. The disclosed invention can be applied to all systems with or without a non-redundant coding system.

Given some knowledge of the vector of the set of fading channel coefficient of each individual channel (h₁, h₂, . . . , h_{N}), the maximum likelihood (ML) metric of the kth bit of the transmitted symbol s is equal to bε{0, 1} is:

$$\begin{matrix}{λ}_{k} ( {y}_{1} , … , {y}_{N} , b ) = log {\sum }_{x ∈ {S}_{k , b}} Pr ( {y}_{1} , … , {y}_{N} \vert s , {h}_{1} , … , {h}_{N} ) \\ ≡ log {\sum }_{x ∈ {S}_{k , b}} exp ( - \frac{1}{2 {σ}^{2}} {\sum }_{i = 1}^{N} {\vert {y}_{i} - {h}_{i} x \vert}^{2} )\end{matrix} \qquad ( 8 )$$

When the same approximation as mentioned earlier is applied to the LLR, the LLR data, Γₖ, of the kth bit of the transmitted symbol s of the optimal receive diversity combining system is:

$${Γ}_{k} ( {y}_{1} , … , {y}_{N} ) = \frac{1}{2 {σ}^{2}} ( {min}_{x ∈ {S}_{k , 0}} {\sum }_{i = 1}^{N} {\vert {y}_{i} - {h}_{i} x \vert}^{2} - {min}_{x ∈ {S}_{k , 1}} {\sum }_{i = 1}^{N} {\vert {y}_{i} - {h}_{i} x \vert}^{2} ) . \qquad ( 9 )$$

The calculation of the above LLR is based on the ML detection; hence it exploits the available signal diversity. Moreover, the ML detection for each bit guarantees that the channel decoder will achieve the available coding gain.

In FIG. 4, the RF and pre-baseband processing module 122 synchronizes, down-converts the received RF signal and sends the down-converted received signal yᵢ 124 and channel fading coefficient hᵢ 126 to the optimal receive diversity combining module 420.

In one embodiment, for example, the system shown in FIG. 4 is a time receive diversity combining system, and blocks 410 and 412 are the similar receive chains but operating at different time instances. In another embodiment, for example, a spatial receive diversity combining system can be realized with blocks 410 and 412 being two independent realizations of the receive chain. It is also contemplated that frequency diversity signals can be processes similarly.

With diversified received signals, the optimal receive combing module 420 combines the down-converted received signal yᵢ 124 with hᵢ 126 of every receive chain block i, generates the LLR 422, and sends it to channel decoder 130.

The LLR data, Γk, of the kth bit of the transmitted symbol s of the optimal receive diversity combining system described in FIG. 4 is then equal to:

$${Γ}_{ML} = \frac{1}{2 {σ}^{2}} ( {min}_{x ∈ {S}_{k , 0}} ( {\vert {y}_{1} - {h}_{1} x \vert}^{2} + {\vert {y}_{2} - {h}_{2} x \vert}^{2} ) - {min}_{x ∈ {S}_{k , 1}} ( {\vert {y}_{1} - {h}_{1} x \vert}^{2} + {\vert {y}_{2} - {h}_{2} x \vert}^{2} ) ) . \qquad ( 10 )$$

Another embodiment of the current invention is diversity combining when multiple different diversity techniques are used. For example, consider an antenna array is used to provide receive diversity for an uplink or downlink transmission, and retransmission techniques (such as ARQ and HARQ) are also used to provide additional copies when the detected packets are erroneous. In such a system, two forms of diversity, i.e. spatial diversity and time diversity, are exploited. This invention states that previous embodiments, illustrated in FIG. 3 and FIG. 4, can also be used for such a combination.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for receive diversity combining, the method comprising:
receiving two or more diversified signals of a predetermined original message;
down-converting the diversified signals;
processing the down converted diversified signals by employing a maximum likelihood (ML) detection to generate a log-likelihood ratio (LLR) data; and
decoding the LLR data to determine the original message.

2. The method of claim 1, wherein the diversified signals are time diversity signals.

3. The method of claim 1, wherein the diversified signals are spatial diversity signals.

4. The method of claim 1, wherein the diversified signals are frequency diversity signals.

5. The method of claim 1, wherein the diversified signals includes at least two or more diversity signals of at least one type (i.e. time, spatial or frequency).

6. The method of claim 1, wherein the employing the Maximum Likelihood (ML) detection further includes obtaining a probability when a kth bit of the transmitted symbol s is equal to bε{0, 1} wherein a mathematical representation is
$$\begin{matrix}{λ}_{k} ( {y}_{1} , … , {y}_{N} , b ) = log {\sum }_{x ∈ {S}_{k , b}} Pr ( {y}_{1} , … , {y}_{N} \vert s , {h}_{1} , … , {h}_{N} ) \\ ≡ log {\sum }_{x ∈ {S}_{k , b}} exp ( - \frac{1}{2 {σ}^{2}} {\sum }_{i = 1}^{N} {\vert {y}_{i} - {h}_{i} x \vert}^{2} ) ;\end{matrix}$$
where a first vector set
(h₁, h₂, . . . , h_{N}) includes a fading channel coefficient of each channel carrying the diversified signal, and a second vector set (y₁, y₂, . . . , y_{N}) including down-converted signals of the channels carrying the diversified signals.

7. The method of claim 5, wherein employing the Maximum Likelihood (ML) detection further includes generating a LLR data Γₖ when the LLR of the kth bit of the transmitted symbol s is equal to the difference of λₖ for the two choices of b wherein a mathematical representation is:
Γₖ(y)=λₖ(y₁, . . . , y_{N}, 0)−λₖ(y₁, . . . , y_{N}, 1)

8. A method for receive signal diversity combining, the method comprising:
receiving two or more diversified signals of a predetermined original message;
down-converting the diversified signals;
processing the down converted diversified signals by employing a maximum likelihood (ML) detection to generate a log-likelihood ratio (LLR) data; and
decoding the LLR data to determine the original message,
wherein the employing the Maximum Likelihood (ML) detection further includes obtaining a probability when a kth bit of the transmitted symbol s is equal to bε{0, 1} wherein a mathematical representation is:
$$\begin{matrix}{λ}_{k} ( {y}_{1} , … , {y}_{N} , b ) = log {\sum }_{x ∈ {S}_{k , b}} Pr ( {y}_{1} , … , {y}_{N} \vert s , {h}_{1} , … , {h}_{N} ) \\ ≡ log {\sum }_{x ∈ {S}_{k , b}} exp ( - \frac{1}{2 {σ}^{2}} {\sum }_{i = 1}^{N} {\vert {y}_{i} - {h}_{i} x \vert}^{2} ) ;\end{matrix}$$
where a first vector set
(h₁, h₂, . . . , h_{N}) includes a fading channel coefficient of each channel carrying the diversified signal, and a second vector set (y₁, y₂, . . . , y_{N}) includes down-converted signals of the channels carrying the diversified signals, and
wherein the employing the Maximum Likelihood (ML) detection further includes generating a LLR data Γₖ when the LLR of the kth bit of the transmitted symbol s is equal to the difference of λₖ for the two choices of b wherein a mathematical representation is
Γₖ(y)=λₖ(y₁, . . . , y_{N}, 0)−λₖ(y₁, . . . , y_{N}, 1)

9. The method of claim 7, wherein the diversified signals are time diversity signals.

10. The method of claim 7, wherein the diversified signals are spatial diversity signals.

11. The method of claim 7, wherein the diversified signals are frequency diversity signals.

12. The method of claim 7, wherein the diversified signals include at least two or more diversity signals of at least one type (i.e. time, spatial or frequency).

13. A receive diversity combining system comprising:
one or more antennas for receiving two or more diversified signals based on an original message;
one or more RF and pre-baseband processing modules associated with the antennas for processing the received diversified signals;
at least one optimal receive diversity combining module for employing Maximum Likelihood (ML) detection to process the diversified signals to generate a Log-Likelihood Ratio (LLR) data; and
at least one decoder for decoding the LLR data to determine the original message.

14. The system of claim 11, wherein the diversified signals are received with one or more antennas placed apart in space.

15. The system of claim 11, wherein the RF and pre-baseband processing modules down-convert the received diversified signals.

16. The system of claim 11, wherein the optimal receive diversity module employing the Maximum Likelihood (ML) detection further obtains a probability when a kth bit of the transmitted symbol s is equal to bε{0, 1} wherein a mathematical representation is:
$$\begin{matrix}{λ}_{k} ( {y}_{1} , … , {y}_{N} , b ) = log {\sum }_{x ∈ {S}_{k , b}} Pr ( {y}_{1} , … , {y}_{N} \vert s , {h}_{1} , … , {h}_{N} ) \\ ≡ log {\sum }_{x ∈ {S}_{k , b}} exp ( - \frac{1}{2 {σ}^{2}} {\sum }_{i = 1}^{N} {\vert {y}_{i} - {h}_{i} x \vert}^{2} ) ;\end{matrix}$$
where a first vector set
(h₁, h₂, . . . , h_{N}) includes a fading channel coefficient of each channel carrying the diversified signal, and a second vector set (y₁, y₂, . . . , y_{N}) including down-converted signals of the channels carrying the diversified signals, and
wherein employing the Maximum Likelihood (ML) detection further includes generating a LLR data Γₖ when the LLR of the kth bit of the transmitted symbol s is equal to the difference of λₖ for the two choices of b wherein a mathematical representation is:
Γₖ(y)=λₖ(y₁, . . . , y_{N}, 0)−λₖ(y₁. . . ., y_{N}, 1)
